(19) United States
(12) Patent Application Publication
(10) Pub. No.: US 2002/0044612 A1
(43) Pub. Date: Apr. 18, 2002

(54) Interleaving method and system

(76) Inventor: Jussi Sipola, Oulu (FI)

Correspondence Address: PILLSBURY WINTHROP LLP, 1600 TYSONS BOULEVARD, MCLEAN, VA, 22102, US

(21) Appl. No.: 09/973,930

(22) Filed: Oct. 11, 2001

Related U.S. Application Data
(63) Continuation of application No. PCT/FI01/00024, filed on Jan. 12, 2001.

(30) Foreign Application Priority Data
Feb. 14, 2000 (FI) 20000312

(51) Int. Cl. H04L 27/04; H04L 27/12; H04L 27/20

(52) U.S. Cl. 375/295

(57) ABSTRACT

The invention relates to a method and an apparatus implementing the method for improving the performance of a radio system using interleaving. In the method of the invention the interleaving depth and the type of interleaving method are selected specifically for each symbol block, the interleaving depth and the interleaving method type of the symbol blocks are signalled to a receiver in order to remove the interleaving, and the interleaving of the symbol blocks is removed using de-interleaving in the receiver. The method of the invention allows to combine rectangular interleaving and diagonal interleaving more efficiently without some blocks remaining partly empty and simultaneously to restrict the delay created in interleaving. The interleaving depth can also be selected block-specifically.

### BACKGROUND OF THE INVENTION

When transferring digital information the reliability of the transfer in a noisy environment is generally improved by increasing redundancy. This is referred to as channel coding. Redundancy is typically increased by means of parity bits. Parity bits are calculated from information bits using particular channel coding algorithms. Channel coding is used to improve error detection as well as error correction. If the parity bits are calculated only using the information bits in the same symbol block, then a block code is concerned. If in turn the information bits in previous symbol blocks are taken into account when calculating the parity bits, then a convolution code is concerned. Decoding is carried out in two stages: at first an erroneous symbol block is detected and the position of the error is determined in the symbol block. The error is corrected by reversing an erroneous bit.

Most of the prior art codes intended to improve the reliability of information transmission are efficient when the radio channel is statistically independent. An example of such a channel is the Additive White Gaussian Noise AWGN channel. However, in actual radio communications environments multi-path propagation and fading cause burst errors when the signal level fades, even beneath the noise level. A code correcting random errors can be employed on a channel where burst errors occur. However, the errors must first be randomised using an interleaver and a de-interleaver. In interleaving the bits are rearranged in accordance with a method before sending them to the channel, and in the receiver interleaving is de-interleaved after demodulation in accordance with the method employed.

Interleaving always causes some delay owing to memory buffering, since a buffer memory has to be used for rearranging the bits in the interleaver and de-interleaver. The interleaving depth refers to the time that is used for sending the bits in one block. In other words, the deeper the interleaving depth is the better the performance of the system becomes, since the bits are more independent, or more random.

The performance of a digital data transmission system is estimated by determining a bit-error-rate BER describing the number of erroneous bits among all received bits. In power-restricted systems the bit-error-rate can be improved by employing different coding methods and modulation methods. A finite K bit information word whose energy is Eₘ, the bit energy E_{b} is determined by means of the energy in the information word

$${E}_{b} = \frac{{E}_{m}}{K}$$

In addition to the energy in the information word the receiver also includes white noise, the single-sided power density of which is Nₒ. The bit-error-rate is often indicated by ratio E_{b}/Nₒ. The performance of different digital data transmission systems can therefore be compared.

The performance of the systems is often also indicated by determining a block-error-rate BLER, referring to the portion of symbol blocks including one or more errors in all the received symbol blocks. The block-error-rate is used in parallel with the bit-error-rate particularly in systems where the erroneous symbol blocks can be resent.

The problem is to find a balance to the interleaving depth between a low bit-error-ratio and a short delay.

In rectangular interleaving the symbol blocks are grouped into sets of a desired size. The bits in each set are rearranged. The size of the symbol block and the number of symbol blocks in the set determine the interleaving depth. FIG. 1 shows an example of the rectangular interleaving principle. In this example the four symbol blocks 100, 102, 104, 106 in the receiver are regrouped so that one block 108, 110 on the radio channel comprises the bits in two original symbol blocks. In such a case the interleaving depth is twice the length of a single symbol block. Interleaving is removed in the receiver and the block structure is identical with the original, i.e. the number of symbol blocks is four. A problem with rectangular interleaving is the excessive delay. A delay of two symbol blocks is created in the transmitter, as the transmission of block 108 cannot be initiated before blocks 100 and 102 are completed. A delay of two symbol blocks is also created in the receiver, since block 100 cannot be de-interleaved until block 108 is entirely received. In total the delay lasts for four symbol blocks. The number of symbol blocks and the interleaving depth may vary from what is described here. In the simplest case the number of symbol blocks included in the set is one, in which case the interleaving comprises only the rearrangement of the bits in one symbol block.

The delay caused by interleaving can be reduced using diagonal interleaving instead of rectangular interleaving. In diagonal interleaving the m bits in the symbol block are sent in blocks m+1, m+2, . . . , m+d, where d is the interleaving depth. FIG. 2 shows an example of diagonal interleaving. The number of symbol blocks and the interleaving depth may vary from what is described here. Blocks 200, 202, 204, 206 in the receiver are regrouped in such a manner that one block on the radio channel comprises bits from two original symbol blocks and the bits in the original symbol block are sent in two regrouped blocks. Blocks 210, 212, 214 on the channel include bits from two original symbol blocks so that block 210 comprises, for example, bits from blocks 200 and 202 and the block 212 includes bits from the blocks 202 and 204. It should be noted that the first block 208 and the last block 216 must partly be filled with other bits, which is indicated in the Figure using letter x. This causes problems in the beginning and at the end of the transmission, when the first and last symbol block remain partly empty. Interleaving is removed in the receiver and the block structure is identical with the original.

FIG. 2 illustrates a case in which a single block delay is created in the receiver, since the transmission of block 208 cannot be initiated until block 200 is completed. A delay of two symbol blocks is created in the receiver, as block 200 cannot be de-interleaved until blocks 208 and 210 are received. In total the delay lasts for three symbol blocks. It should be noted that the interleaving depth is twice the length of a single symbol block, or the same as the one shown in rectangular interleaving in FIG. 1, but the delay is one symbol block shorter.

### BRIEF DESCRIPTION OF THE INVENTION

It is an object of the invention to provide a method and an apparatus implementing the method so as to employ interleaving more efficiently without some blocks remaining partly empty and to simultaneously restrict the delay caused by interleaving. This is achieved with a method for improving the performance of a radio system by interleaving and de-interleaving symbol blocks including bits. The method of the invention comprises the steps of combining rectangular interleaving and diagonal interleaving, selecting the interleaving depth and the type of interleaving method specifically for each symbol block, signalling the interleaving depth and the interleaving method type of the symbol blocks to a receiver in order to remove the interleaving and removing the interleaving of the symbol blocks using de-interleaving in the receiver.

The invention also relates to a radio system in which symbol blocks including bits are interleaved and de-interleaved in order to improve the performance of the radio system. In the system of the invention a transmitter comprises means for combining rectangular interleaving and diagonal interleaving, the transmitter comprises means for selecting the interleaving depth and the type of interleaving method specifically for each symbol block, the transmitter comprises means for signalling the symbol block-specific interleaving depth and interleaving method type to a receiver in order to remove the interleaving, and the receiver comprises means for removing the symbol block interleaving using de-interleaving.

The invention further relates to a radio transmitter in which symbol blocks including bits are interleaved in order to improve the performance of a radio system. The transmitter of the invention comprises means for combining rectangular interleaving and diagonal interleaving, the transmitter comprises means for selecting the interleaving depth and the type of interleaving method specifically for each symbol block and the transmitter comprises means for signalling the symbol block-specific interleaving depth and interleaving method type to the receiver in order to remove the interleaving.

The invention also relates to a radio receiver in which symbol blocks including bits are de-interleaved in order to improve the performance of a radio system. The receiver of the invention comprises means for receiving and interpreting signalling data concerning the symbol block-specific interleaving depth and interleaving method type of the received symbol blocks, and the receiver comprises means for removing the symbol block-specific interleaving of the symbol blocks using de-interleaving.

The preferred embodiments of the invention are disclosed in the dependent claims.

Several advantages are achieved with the method and system of the invention. In accordance with the prior art rectangular interleaving or diagonal interleaving must be selected, whereas the method of the invention provides a chance to dynamically change the type of interleaving method as well as the interleaving depth block-specifically. The interleaving thus provides an improvement to the error tolerance of the system and simultaneously allows to adjust the length of the delay caused by interleaving. The method of the invention can also be used for smoothly multiplexing several transmitters together also when diagonal interleaving is used. This occurs by selecting the interleaving method type and interleaving depth so as to provide a changing point for the interleaving set, when all the symbol blocks are entirely sent, whose transmission is initiated before the changing point. In addition, the provided changing point of the interleaving set can be used for changing the modulation method or the receiver of the transmission, for example.

### BRIEF DESCRIPTION OF THE DRAWINGS

In the following the invention will be explained in greater detail by means of the preferred embodiments with reference to the accompanying drawings, in which

FIG. 1 shows rectangular interleaving,

FIG. 2 shows diagonal interleaving,

FIG. 3 illustrates an example of a telecommunications system,

FIG. 4 shows an example of a transmitter,

FIG. 5 shows an example of a receiver,

FIG. 6 is a block diagram showing the method steps required in an interleaver of the transmitter,

FIG. 7 is a block diagram showing the method steps required in a de-interleaver of the receiver, and

FIGS. 8a to 8f illustrate an example of how interleaving methods are combined.

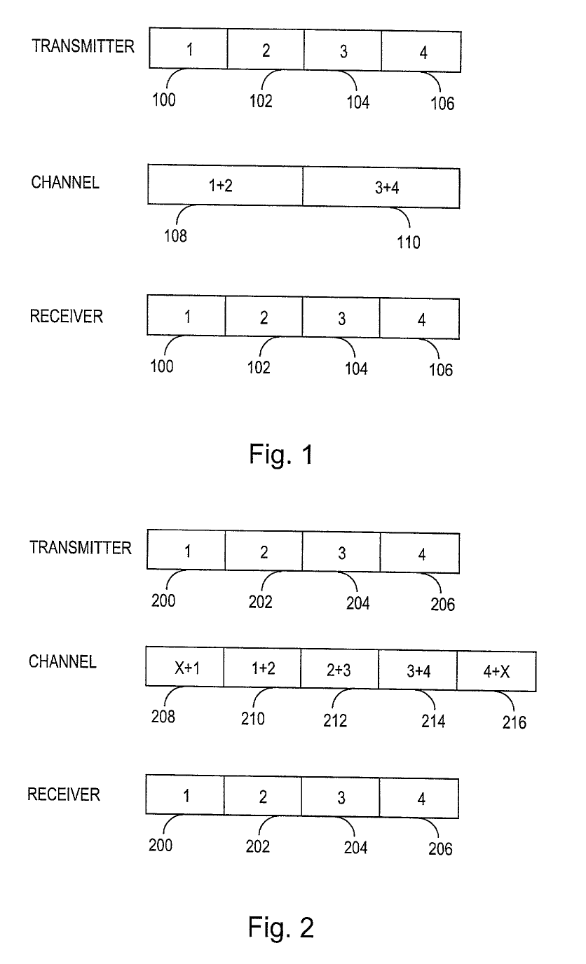

### DETAILED DESCRIPTION OF THE INVENTION

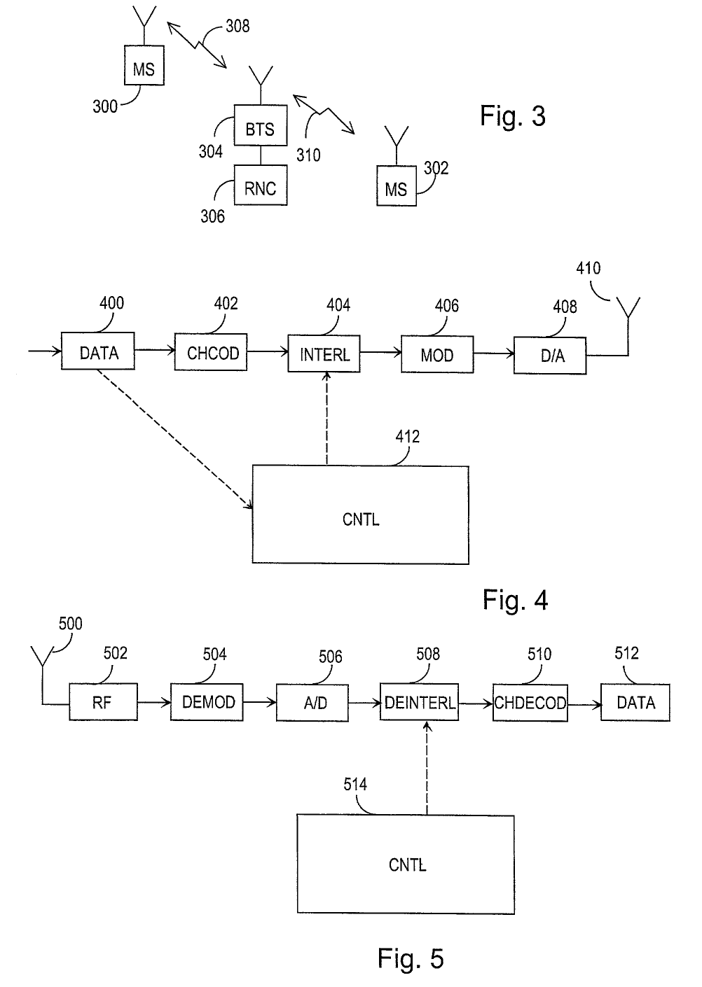

The present invention may be employed in different wireless communications methods such as cellular radio systems. The multiple access method to be used is not relevant. For example, the CDMA (Code Division Multiple Access), the WCDMA (Wideband Code Division Multiple Access) and the TDMA (Time Division Multiple Access) or the hybrids thereof are all possible. It is obvious for those skilled in the art that the method of the invention can also be applied to systems using different modulation methods or air interface standards. FIG. 3 illustrates in a simplified manner a digital data transmission system, to which the solution of the invention can be applied. What is concerned is a part of a cellular radio system, which comprises a base station 304 having a bidirectional connection 308 and 310 with subscriber terminals 300 and 302 that may be fixedly located, vehicle mounted or portable hand-held terminals. The base station comprises, for instance, transceivers. The base station transceivers communicate with an antenna unit that allows to implement a bidirectional radio connection with the subscriber terminal. The base station also communicates with a base station controller 306 that transmits the terminal connections to other parts of the network. The base station controller controls several base stations communicating therewith in a centralized manner. The base station controller comprises a group switching field, which is used to connect speech and data and to combine signalling circuits.

The cellular radio system may also communicate with a public switched telephone network, in which case a transcoder converts different digital speech coding modes used between a public switched telephone network and a cellular radio network to suit one another, for instance, from the 64 kbit/s fixed network form to another form (such as 13 kbit/s) of the cellular radio network, and vice versa.

FIG. 4 illustrates a simplified view of a radio transmitter according to the preferred embodiment of the invention. The transmitter described may be located, for example, in the network part of the radio system, such as the base station, or in the subscriber terminal or in the control part of the radio system, such as the base station controller, typically in such system solutions where network part functions are connected to the control part. The subscriber terminal may, for example, be a portable phone or a microcomputer without being restricted thereto. Information 400 may be speech, data, moving or still video image. The required control channels are formed in a control part 412 of the transmitter. The control part controls the device itself as well as the communication connection. For clarity, the Figure does not show speech or data codecs, for example. The information is channel coded in a channel codec 402. Block codes, such as a Cyclic Redundancy Check (CRC), are examples of channel codes. Another typical way to implement channel coding is convolution coding and the various modifications thereof, such as punctured convolution coding. In the WCDMA system (Wideband Code Division Multiple Access) concatenated convolution coding, or turbo coding, is also employed.

After channel coding, the information is interleaved in an interleaver 404. The control part 412 comprises an algorithm that allows to adjust the interleaving depth and to select the interleaving method. What affects the choice of interleaving depth is typically the delay restrictions, bit-error-rate requirements or the quality (speech or data) of the symbol block load. The control part 412 comprises means for indicating the delay requirements and means for indicating the quality requirements that depend on the information to be transferred. The control part may also receive network level information.

Also in spread spectrum systems, such as the WCDMA, the pseudo-random noise code allows the signal spectrum to be spread in the transmitter to a broad band and to be composed in the receiver, thus attempting to increase the channel capacity. Coding can also be used for enciphering the transmission or the information therein. In addition, the apparatuses according to the GSM system (Groupe Special Mobile) typically include burst formation means that add the tail bits of the burst and the training sequence to the data arriving from the channel codec.

In the modulation block 406 the carrier wave is modulated using a data signal including the desired information in accordance with the selected modulation method. The modulation block may also comprise power amplifiers and filters limiting the frequency band. After modulation the signal is D/A converted in block 408. The obtained analogue signal is mixed to the desired transmission frequency and sent by means of an antenna 410 onto the radio channel. The antenna may also be a directed group antenna or the system may comprise antenna diversity. The system may also include several transmitters.

The transmitter can be implemented either by means of an apparatus solution, by software or as a combination thereof.

FIG. 5 is a simplified view showing the radio receiver according to the preferred embodiment of the invention. The presented receiver may be located for example in a network part of the radio system, such as a base station, or in a subscriber terminal or in a control part of the radio system, such as base station controllers, typically in such system solutions where the network part functions are connected to the control part. The subscriber terminal may be, for example, a portable phone or a microcomputer without being restricted thereto. The coding method used, the interleaving method and interleaving depth are decided in the transmitter taking the quality requirements and delay restrictions into account. The receiver must be able to remove the codings and interleavings performed. The required information is signalled to the receiver for example together with the data blocks or on a signalling channel. A control part 514 of the receiver receives the signalling data. The receiver may comprise one or more antennas or antenna groups 500. The receiver may also be a RAKE receiver used in the WCDMA system (Wideband Code Division Multiple Access). If the system employs pilot symbols for transmitting signalling data, the pilot symbols must be indicated before the actual information symbols. Then the received symbols must be stored into a buffer memory. The symbol may comprise one or more bits.

The received signal is at first applied to radio frequency parts 502 comprising filters filtering the frequencies outside the desired frequency band. Thereafter, the signal is converted into an intermediate frequency or directly into a baseband. In a demodulator 504 the signal is demodulated, or the information signal is distinguished from the carrier. A baseband analogue signal is sampled and quantized in an A/D converter 506. If the receiver in question is a RAKE receiver, the multipath propagated signal components received by the different branches are combined, and in this way as much as possible of the sent signal energy is received. Next the signal interleaving is removed in a de-interleaver 508. Thereafter the channel coding of the signal is removed in a decoder 510, and sent data 512 can thereby be indicated. If another type of coding is used, such as coding made to encipher the information, these codings must also be removed. The convolution coded signal is typically decoded using a Viterbi detector. If the received signal is broadband, the spread signal must be composed in the receiver.

The receiver is implemented by means of an apparatus solution, by software or as a combination thereof.

In the following a preferred embodiment of the invention will be explained in more detail. The method of the invention employs interleaving and de-interleaving for improving the performance of a radio system. In the method, the interleaving depth and the type of interleaving method, generally rectangular interleaving or diagonal interleaving, can be specifically selected for each symbol block. The interleaving depth of the symbol blocks and the interleaving method type is signalled to the receiver in order to remove the interleaving.

The quality of the information to be transferred affects the choice of the interleaving method type and the interleaving depth. In order to select the interleaving method type and the interleaving depth, the transmitter, in which the interleaver is located, may obtain a command from the other units in the system, such as the base station controller, or the transmitter can make the selection decision itself, for example, by examining the contents of the block to be interleaved. It is preferable to select diagonal interleaving for interleaving speech, since the delay caused by diagonal interleaving is smaller than that of rectangular interleaving. Rectangular interleaving providing a low interleaving depth is typically selected for packet-mode data transmission, since minimizing the block-error-rate is more important than minimizing the bit-error-rate. The quality of the transmission path substantially affects the choice of the interleaving depth: the noisier the radio channel is the more random the bits must be obtained. The performance of the system can thus be improved. The success of a data transmission in the GSM system is studied by measuring the bit-error-rate at regular intervals. A preferred embodiment of the invention is to select the interleaving depth specifically for each symbol block based on the bit-error-rate measurements.

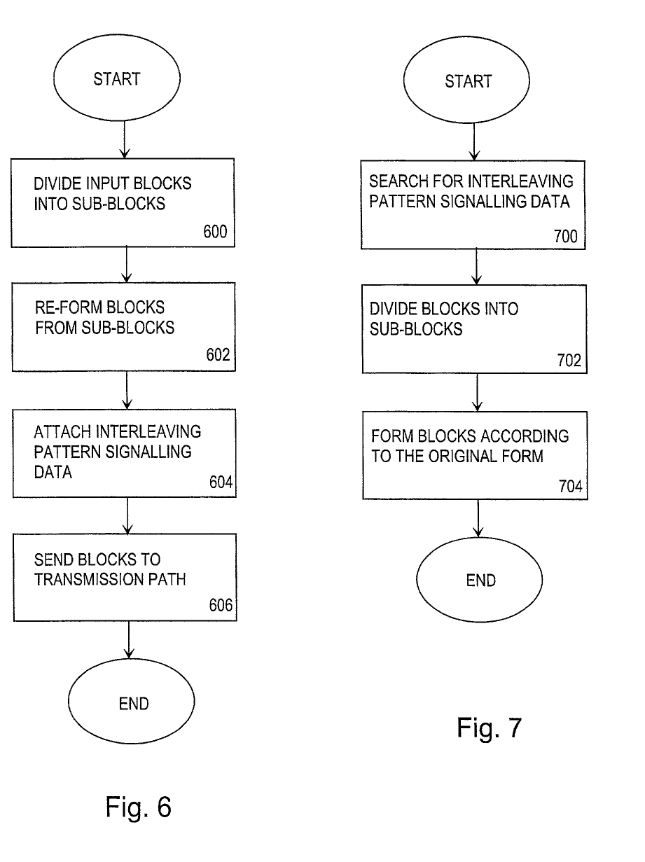

FIG. 6 is a block diagram showing the method steps required in a transmitter interleaver. In block 600 the incoming blocks arriving at the interleaver are divided into smaller sub-blocks. The number of sub-blocks, into which each incoming block is divided, depends on the applied system standard. The application of the invention does not restrict the number of sub-blocks in any way.

In block 602 new symbol blocks are formed of the sub-blocks in the interleaver by combining rectangular interleaving with diagonal interleaving. What affects the choice of the interleaving method is whether the transmitter has just received a transmission turn or whether the transmitter is about to end the transmission. It should be noted that at the final stage of the transmission the symbol blocks are filled and no transmission time needs to be wasted for sending totally or partly empty symbol blocks. The number of symbol blocks to be interleaved determines the interleaving depth. The application of the invention does not restrict the interleaving depth, instead the delay restrictions and fading properties of the radio channel affect the choice of the interleaving depth. A slower the fading channel requires a greater interleaving depth in order to make the errors as random as possible. Typically rectangular interleaving providing a small interleaving depth is selected for the data blocks of packet-mode data transmission, as the minimizing of the block-error-rate is more important than minimizing the bit-error-rate. Diagonal interleaving is typically selected for speech blocks, as the delay caused by diagonal interleaving is smaller.

In order for a transmitter to be able to remove interleaving, a used interleaving pattern is signalled to the transmitter, for example as shown in block 604, by connecting the signalling data to one or more output blocks. It is also possible to use a signalling channel according to the standard used at a particular time, a separate pilot block or a signalling block that comprise only the interleaving pattern information or other signalling data. The re-formed output blocks are sent onto the radio channel in block 606.

FIG. 7 is a block diagram showing the method steps required in a receiver de-interleaver. Signalling data about the type of interleaving pattern used in the transmitter is searched for in block 700. The interleaving of the incoming blocks in the receiver is removed in block 702 by dividing the symbol blocks including information bits into sub-blocks. The interleaving cannot be removed without the information provided by the signalling data on the interleaving pattern, and therefore the signalling data can be resent in order to ensure the reception of the signalling data, if the radio channel is particularly noisy and said symbol block is very important.

Next new symbol blocks are formed of the sub-blocks in the de-interleaver in accordance with block 704, the symbol blocks being completely identical with the original symbol blocks in the transmitter except for possible bit errors created during transmission. Consequently the interleaving of the symbol blocks is removed and the information bits can be applied to the decoder.

What is characteristic for packet-data traffic is that the reception of a data-packet may fail. In such a situation the receiver requires the transmitter to resend said data-packet. When retransmitting a data-packet the modulation level is typically changed or a more efficient coding is employed in order to achieve an improved error tolerance and a successful transmission. The method of the invention can also be applied in such a situation. The interleaving depth is altered during the retransmission of data packets, thus providing a better error tolerance. The interleaving depth can also be changed for the transmission of each symbol block by measuring the transmission channel in advance, in which case the fading properties of a channel can for instance be determined.

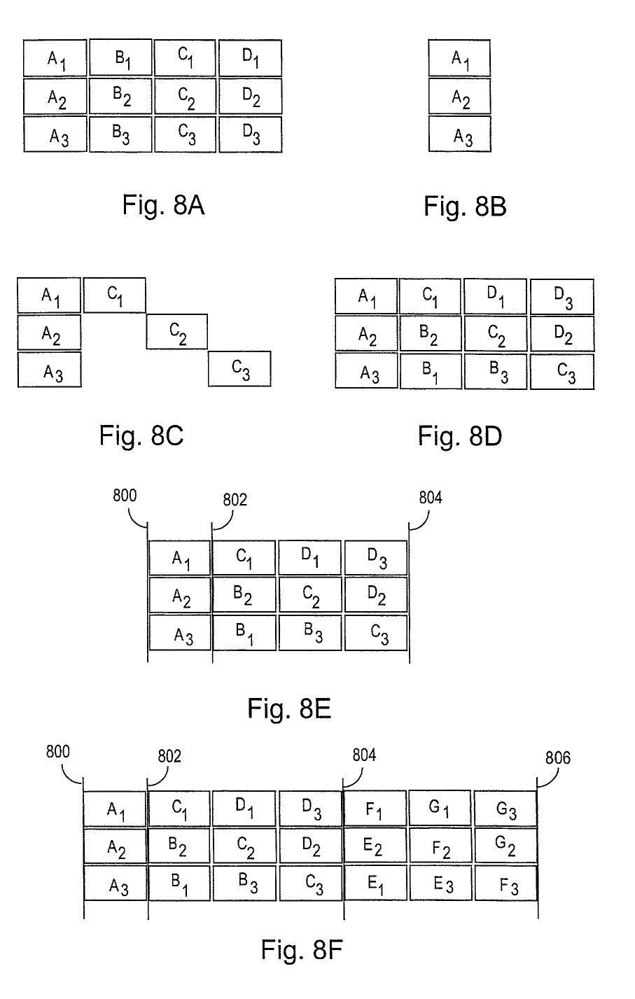

FIGS. 8a to 8f illustrate a simple example of how an interleaving pattern is created. In this example each original symbol block is divided into three sub-blocks, which are then grouped by connecting rectangular interleaving and diagonal interleaving. FIG. 8a shows the original input blocks of the transmitter. FIG. 8b illustrates how the rectangular interleaved sub-blocks A₁, A₂ and A₃ of symbol block A remain stationary. Then in FIG. 8c the sub-blocks C₁, C₂ and C₃ of symbol block C are interleaved using diagonal interleaving; C₁ moves one sub-block backwards, C₂ remains in position and C₃ moves one sub-block forward. FIG. 8d illustrates the output of the interleaver. An output block is composed of three overlapping sub-blocks in the Figure. The Figure shows how the other sub-blocks B₁, B₂ and B₃ and D₁, D₂ and D₃ are used to fill the remaining space. Sub-blocks B₂ and B₃ are diagonally grouped as well as sub-blocks D₁ and D₂. The sub-triangle formed between the diagonal and the rectangular is filled with sub-block B₁. A corresponding top-triangle is filled with sub-block D₃.

The number of sub-blocks to be interleaved follows the formula 2n+1, where n is the number of symbol blocks required to fill the space between the diagonal and the rectangular for each space to be filled, and therefore the number of sub-blocks may deviate from what is presented in the Figures. It should be noted that the sub-blocks of more than one symbol blocks can be used to fill the spaces. All blocks to be sent are typically interleaved using an interleaving method.

In FIG. 8e, lines 800, 802, 804 indicate a point, at which a changing point is created for the interleaving group. All the symbol blocks, whose transmission is initiated before the changing point, are sent entirely at the changing point of the interleaving group. Such a changing point is created in order to be able to change, for example, the modulation method or if a cellular radio system is concerned to distribute a transmission turn for different subscriber terminals to the base station. The changing point is also provided in order to change the receiver of the transmission. The receiver of the transmission is typically changed by directing the antenna beams of the transmitter. As the receiver of the transmission is changed the transmission power can simultaneously be adjusted.

FIG. 8f shows how a changing point can be provided between two groups using diagonal interleaving. The changing points are indicted using lines 800, 802, 804 and 806. Sub-blocks F₁, F₂ and F₃ are interleaved as sub-blocks C₁, C₂ and C₃, and sub-blocks E₁, E₂ and E₃ are interleaved in the same way as sub-blocks B₁, B₂ and B₃ and sub-blocks G₁, G₂ and G₃ are interleaved in the same way as sub-blocks D₁, D₂ and D₃.

In the examples shown in FIGS. 8a to 8f the signalling data to be indicated in the interleaving pattern is included in the middlemost sub-block of each symbol block, which in this case is sub-block 2, as the position of said sub-block does not change and is therefore known. The interleaving pattern data can also be indicated with two bits in the interleaving data field.

A bursty transmission is typical for the GSM system. In such a system the output blocks of the interleaver are divided, for example, into four parts, each one of which being sent in a specific burst thereof.

It should be noted that in addition to the method of the invention additional interleaving can also be employed, such as additional rectangular interleaving in the input blocks of the interleaver in the transmitter and correspondingly the additional interleaving can be removed from the de-interleaver in the receiver, or additional rectangular interleaving can be used sub-block-specifically or output block-specifically.

Even though the invention has been described above with reference to the example of the accompanying drawings, it is obvious that the invention is not restricted thereto but can be modified in various ways within the scope of the inventive idea disclosed in the attached claims.

1. A method for improving the performance of a radio system by interleaving and de-interleaving symbol blocks including bits, comprising:
combining rectangular interleaving and diagonal interleaving,
selecting the interleaving depth and the type of interleaving method specifically for each symbol block,
signalling the interleaving depth and the interleaving method type of the symbol blocks to a receiver in order to remove the interleaving, and
removing the interleaving of the symbol blocks using de-interleaving in the receiver.

2. A method as claimed in claim 1 wherein the information concerning the interleaving depth and interleaving method type is signalled to the receiver as a part of a sub-block.

3. A method as claimed in claim 1 wherein the information concerning the interleaving depth and interleaving method type is signalled to the receiver in a separate information block.

4. A method as claimed in claim 1 wherein the information concerning the interleaving depth and interleaving method type is signalled to the receiver using a separate signalling channel.

5. A method as claimed in any one of preceding claims wherein the interleaving depth and interleaving method type are selected according to the quality of the symbol block load.

6. A method as claimed in any one of preceding claims wherein the interleaving depth and interleaving method type are changed on the basis of the measurements carried out on the transmission channel.

7. A method as claimed in any one of preceding claims wherein the interleaving depth and interleaving method type are changed on the basis of a coding method.

8. A method as claimed in any one of preceding claims wherein the interleaving depth and interleaving method type are changed during retransmission of packet-mode data.

9. A method as claimed in any one of preceding claims wherein the interleaving depth and interleaving method type are selected so as to provide a changing point for an interleaving set, when all the symbol blocks are entirely sent, whose transmission is initiated before said changing point of the interleaving set.

10. A method as claimed in claim 9 wherein a modulation method is changed at the provided changing point of the interleaving set.

11. A method as claimed in claim 9 wherein a transmission turn is transferred to a second transmitter at the provided changing point of the interleaving set.

12. A method as claimed in claim 9 wherein a receiver of the transmission is changed at provided the changing point of the interleaving set.

13. A method as claimed in claim 12 wherein the receiver of the transmission is selected by directing the antenna beams of the receiver.

14. A method as claimed in claim 12 wherein transmission power is adjusted when the receiver of the transmission changes.

15. A radio system in which symbol blocks including bits are interleaved and de-interleaved in order to improve the performance of the radio system, comprising:
a transmitter comprises means for combining rectangular interleaving and diagonal interleaving,
the transmitter comprises means for selecting the interleaving depth and the type of interleaving method specifically for each symbol block,
the transmitter comprises means for signalling the symbol block-specific interleaving depth and interleaving method type to a receiver in order to remove the interleaving, and
the receiver comprises means for removing the symbol block interleaving using de-interleaving.

16. A system as claimed in claim 15 wherein the transmitter comprises means for signalling data concerning the interleaving depth and interleaving method type to the receiver as a part of a sub-block.

17. A system as claimed in claim 15 wherein the transmitter comprises the means for signalling the data concerning the interleaving depth and interleaving method type to the receiver in a separate information block.

18. A system as claimed in claim 15 wherein the transmitter comprises the means for signalling the data concerning the interleaving depth and interleaving method type to the receiver on a separate signalling channel.

19. A system as claimed in any one of preceding claims wherein the transmitter comprises means for selecting the interleaving depth and interleaving method type according to the quality of the symbol block load.

20. A system as claimed in any one of preceding claims wherein the transmitter comprises the means for changing the interleaving depth and interleaving method type on the basis of the measurements carried out on the transmission channel.

21. A system as claimed in any one of preceding claims wherein the transmitter comprises the means for changing the interleaving depth and interleaving method type on the basis of a coding method.

22. A system as claimed in any one of preceding claims wherein the transmitter comprises means for changing the interleaving depth and interleaving method type during retransmission of packet-mode data.

23. A system as claimed in any one of preceding claims wherein the transmitter comprises the means for selecting the interleaving depth and interleaving method type so as to provide a changing point for the interleaving set, when all the symbol blocks are entirely sent whose transmission is initiated before said changing point of the interleaving set.

24. A system as claimed in claim 23 wherein the transmitter comprises means for changing a modulation method at the provided changing point of the interleaving set.

25. A system as claimed in claim 23 wherein the transmitter comprises the means for creating the changing point of the interleaving set in the beginning or at the end of a transmission turn.

26. A system as claimed in claim 23 wherein the transmitter comprises means for changing the receiver of the transmission at the provided changing point of the interleaving set.

27. A system as claimed in claim 26 wherein the transmitter comprises the means for changing the receiver by directing the antenna beams of the transmitter.

28. A system as claimed in claim 26 wherein the transmitter comprises the means for adjusting transmission power when the receiver of the transmission is changed.

29. A radio transmitter in which symbol blocks including bits are interleaved in order to improve the performance of a radio system, comprising
means for combining rectangular interleaving and diagonal interleaving,
means for selecting the interleaving depth and the type of interleaving method specifically for each symbol block, and
means for signalling the symbol block-specific interleaving depth and interleaving method type to the receiver in order to remove the interleaving.

30. A transmitter as claimed in claim 29 wherein the transmitter comprises the means for signalling data concerning the interleaving depth and interleaving method type to the receiver as a part of a sub-block.

31. A transmitter as claimed in claim 29 wherein the transmitter comprises the means for signalling the data concerning the interleaving depth and interleaving method type to the receiver in a separate information block.

32. A transmitter as claimed in claim 29 wherein the transmitter comprises the means for signalling the data concerning the interleaving depth and interleaving method type to the receiver on a separate signalling channel.

33. A transmitter as claimed in any one of preceding claims wherein the transmitter comprises means for selecting the interleaving depth and interleaving method type according to the quality of the symbol block load.

34. A transmitter as claimed in any one of preceding claims wherein the transmitter comprises the means for changing the interleaving depth and interleaving method type on the basis of the measurements carried out on the transmission channel.

35. A transmitter as claimed in any one of preceding claims wherein the transmitter comprises means for changing the interleaving depth and interleaving method type on the basis of a coding method.

36. A transmitter as claimed in any one of preceding claims wherein the transmitter comprises the means for changing the interleaving depth and interleaving method type during retransmission of packet-mode data.

37. A transmitter as claimed in any one of preceding claims wherein the transmitter comprises the means for selecting the interleaving depth and interleaving method type so as to provide a changing point for an interleaving set, when all the symbol blocks are entirely sent whose transmission is initiated before said changing point of the interleaving set.

38. A transmitter as claimed in claim 37 wherein the transmitter comprises means for changing a modulation method at the provided changing point of the interleaving set.

39. A transmitter as claimed in claim 37 wherein the transmitter comprises the means for creating the changing point of the interleaving set in the beginning or at the end of a transmission turn.

40. A transmitter as claimed in claim 37 wherein the transmitter comprises means for selecting the receiver of the transmission at the provided changing point of the interleaving set.

41. A transmitter as claimed in claim 40 wherein the transmitter comprises the means for changing the receiver by directing the antenna beams of the transmitter.

42. A transmitter as claimed in claim 40 wherein the transmitter comprises the means for adjusting transmission power when changing the receiver of the transmission.

43. A transmitter as claimed in claim 29 wherein the transmitter is located in a subscriber terminal.

44. A transmitter as claimed in claim 29 wherein the transmitter is located in a network part of the radio system.

45. A transmitter as claimed in claim 29 wherein the transmitter is located in a control part of the radio system.

46. A radio receiver in which symbol blocks including bits are de-interleaved in order to improve the performance of a radio system, comprising
means for receiving and interpreting signalling data concerning the symbol block-specific interleaving depth and interleaving method type of the received symbol blocks, and
means for removing the symbol block-specific interleaving of the symbol blocks using de-interleaving.

47. A receiver as claimed in claim 46 wherein the receiver is located in a subscriber terminal.

48. A receiver as claimed in claim 46 wherein the receiver is located in a network part of the radio system.

49. A receiver as claimed in claim 46 wherein the receiver is located in a control part of the radio system.
